(19) United States
(12) Patent Application Publication
(10) Pub. No.: US 2025/0019205 A1
(43) Pub. Date: Jan. 16, 2025

(54) SYSTEM AND METHOD FOR DETERMINING THE POSITION OF AN ELEVATOR CAR OF AN ELEVATOR UNIT, THE ELEVATOR CAR BEING MOVABLE IN AN ELEVATOR SHAFT

(71) Applicant: Inventio AG, Hergiswil (CH)

(72) Inventors: Beat De Coi, Maienfeld (CH); Christian Studer, Kriens (CH); Axel Hosemann, Auw (CH); Udo Graf, Sevelen (CH)

(21) Appl. No.: 18/712,742

(22) PCT Filed: Nov. 3, 2022
(86) PCT No.: PCT/EP2022/080704

§ 371 Date: May 23, 2024

(30) Foreign Application Priority Data
Nov. 30, 2021 (EP) 21211346.8

(51) Int. Cl. B66B 1/34; B66B 5/00; G01S 17/894

(52) U.S. Cl. CPC B66B 1/3492; B66B 5/0018; G01S 17/894

(57) ABSTRACT

A system and method determine the position of an elevator car movably arranged in an elevator shaft of an elevator system. The system has a 3D sensor, an evaluation unit communicating with the sensor, and a marking element. The sensor has a plurality of sensor cells and the evaluation unit uses measurement data received from the sensor to determine a distance from each sensor cell to a part of a detected object. The sensor is arranged such that in a normal mode of the system it detects the marking element as the object. The evaluation unit determines the position of the elevator car in the elevator shaft based on distances from sensor cells to the detected part of the object, continuously performs a test as to whether the sensor detects the marking element and brings the system into an error mode as soon as the test is negative.

### FIELD

The invention relates to a system for determining the position of an elevator car, movably arranged in an elevator shaft, of an elevator installation, and to a method for determining the position of an elevator car, movably arranged in an elevator shaft, of an elevator installation having the features described herein.

### BACKGROUND

Elevator installations are used to transport persons and/or goods between floors of buildings. For this purpose, at least one elevator car accommodating passengers and/or goods is moved in an elevator shaft, in particular vertically between the floors. The position of the elevator car in the elevator shaft must be determined and processed by an elevator control system in order to be able to stop the elevator car precisely at a floor. It is also possible for a permitted travel range of the elevator car in the elevator shaft to be ensured exclusively by monitoring the position of the elevator car, and to dispense with so-called limit switches installed in the elevator shaft. In this case, a safe or reliable determination of the position of the elevator car in the elevator shaft is important. A procedure of this kind is described in EP 3434634 B1, for example.

A plurality of systems are known for determining the position of an elevator car in an elevator shaft, based on a wide variety of measuring designs. For example, EP 1390284 B1 describes a system for determining the position of an elevator car of an elevator installation that is movably arranged in an elevator shaft, in which a code band extending over the entire elevator shaft is scanned and the position of the elevator car is determined from the information read out.

EP 3452396 B1 describes a system for determining the position of an elevator car, movably arranged in an elevator shaft, of an elevator installation, having a 3D sensor in the form of a 3D camera, an evaluation unit in the form of a computer system and a marking element in the form of an edge between a shaft wall and a shaft floor. The 3D camera is arranged on the elevator car and has multiple sensor cells. It is arranged such that it detects the mentioned edge and a region around the edge as an object. The computer system is configured to use measurement data received from the 3D camera to determine a distance from each sensor cell to a part of an object detected by the 3D camera detected by that sensor cell, and to determine the position of the elevator car in the elevator shaft based on distances from sensor cells to a part, detected by those sensor cells, of the object detected by the 3D camera.

### SUMMARY

In particular, it is an object of the invention to propose a system and a method for determining the position of an elevator car of an elevator installation which is movably arranged in an elevator shaft and which enables a particularly reliable determination of the position of the elevator car and thus a particularly reliable operation of an elevator installation comprising the system or using the method. According to the invention, this object is achieved by a system having the features and by a method having the features described below.

The embodiments described below relate equally to the system and to the method. In other words, features mentioned below for example with reference to the system can also be implemented as method steps, and vice versa. The system is thus designed and configured in particular such that it can carry out the described methods, i.e., the described methods can be carried out by the system.

The system according to the invention for determining the position of an elevator car, arranged movably in an elevator shaft, of an elevator installation has a 3D sensor, an evaluation unit in communication with the 3D sensor, and a marking element. Of the two components 3D sensor and marking element, one component is arranged immovably in the elevator shaft and the other component is arranged on the elevator car. The 3D sensor has multiple sensor cells and the evaluation unit is configured to use measurement data received from the 3D sensor to determine a distance from each sensor cell to a part, detected by this sensor cell, of an object detected by the 3D sensor. The 3D sensor is arranged such that in a normal mode of the system it detects the marking element as an object. The evaluation unit is configured to determine the position of the elevator car in the elevator shaft based on distances from sensor cells to a part, detected by these sensor cells, of the object detected by the 3D sensor, to continuously perform a test as to whether the 3D sensor detects the marking element, and to bring the system into an error mode as soon as the test turns out negative.

This ensures that the system is only in normal mode when the 3D sensor detects the marking element and the position of the elevator car in the elevator shaft can therefore be reliably determined. Conversely, it is ensured that the system is immediately switched into the error mode if the 3D sensor does not detect the marking element and therefore the position of the elevator car in the elevator shaft cannot be reliably determined. The 3D Sensor cannot detect the marking element for example if the orientation of the 3D sensor has changed, for example due to a loose fastening. As soon as the system is in error mode, in particular the operation of the elevator system is restricted or stopped completely. This can be initiated by the system itself or by a control device or safety device of the elevator installation which is in communication with the evaluation unit of the system. In addition to the position of the elevator car, the evaluation unit can, for example, output information about its current mode, i.e., at least, normal mode or error mode. The system is therefore part of a safety system of the elevator installation. The design of the system according to the invention makes it possible to fulfill the requirements of the safety integrity level (SIL) SIL-3.

Apart from the 3D sensor, the evaluation unit, and the marking element, the system does not require any other components to be installed in the elevator shaft or on the elevator car. In particular, no code band extending over the entire elevator shaft has to be installed. The system according to the invention therefore requires only low installation effort.

The mentioned object is also achieved by a method for determining the position of an elevator car, movably arranged in an elevator shaft, of an elevator installation with a system described above for determining the position of an elevator car, movably arranged in an elevator shaft, of an elevator installation. The evaluation unit determines the position of the elevator car in the elevator shaft based on distances from sensor cells to a part, detected by these sensor cells, of the object detected by the 3D sensor, continuously carries out a test as to whether the 3D sensor detects the marking element, and brings the system into an error mode as soon as the test turns out negative.

The 3D sensor and the evaluation unit are arranged in close spatial proximity to each other, for example in a common housing. However, it is also possible for the 3D sensor and the evaluation unit to be arranged spatially apart from each other. It is also possible for the evaluation unit to consist of multiple parts or modules which are in communication with one another and which can be arranged at least partially in the 3D sensor or at a distance therefrom. At least one module of the evaluation unit can also be designed as a control device which executes other control tasks in the elevator installation.

The following options are available for the arrangement of the 3D sensor on the one hand and the marking element on the other:
the 3D Sensor is immovable at one end of the elevator shaft and the marking element is arranged on a side of the elevator car facing the 3D sensor, or
the marking element is arranged immovably at one end of the elevator shaft and the 3D sensor is arranged on a side of the elevator car facing the marking element.

Thus, either the marking element or the 3D sensor is moved with the elevator car in the elevator shaft, and the corresponding other part is arranged immovably, in particular at an end of the elevator shaft. Since the elevator shaft is mainly aligned vertically, either the marking element or the 3D sensor is arranged immovably at the lower end or at the upper end of the elevator shaft. The position or height at which the marking element or 3D sensor is arranged in the elevator shaft is known. It is also known at which point the corresponding other part is arranged on the elevator car. The position of the elevator car in the elevator shaft can thus be determined from the specified fixed position of the marking element or the 3D sensor in the elevator shaft and the distance to the marking element determined by means of the 3D sensor or to a region adjacent to the marking element. In the case of a vertically aligned elevator shaft, the position of the elevator car in the elevator shaft determines the height at which the elevator car is located. The position of the elevator car can be determined at any time. Here it is not necessary for a previous position of the elevator car to be known.

In particular, the 3D sensor and the evaluation unit are part of a so-called 3D camera. 3D cameras are commercially available at comparatively low prices.

The 3D sensor is designed in particular as a photonic mixing detector, also known as a PMD sensor (photonic mixing device), whose functional principle is based on the time-of-flight method. In this case, the 3D camera comprising the 3D sensor is designed as a so-called time-of-flight camera, or TOF camera for short. The TOF camera, and thus the system for determining the position of an elevator car in an elevator shaft, thus have a transmitter for emitting electromagnetic radiation. The 3D sensor is then configured to determine, for each sensor cell, a propagation time of the electromagnetic radiation emitted by the transmitter and reflected by the detected object and to transmit it to the evaluation unit via the mentioned communication link. The evaluation unit is then configured to determine the distance of each sensor cell from a part, detected by this sensor cell, of the object detected by the 3D sensor on the basis of the mentioned propagation times. It is also possible for the 3D sensor to transmit measurement data to the evaluation unit and for the evaluation unit to use this data to determine the named propagation times and thus the named distances. The propagation times mentioned are determined in particular by determining a phase shift of the electromagnetic radiation emitted by the transmitter and reflected by the detected object. The 3D sensor can, for example, have multiple TOF distance sensors described in EP 2743724 B1, wherein each of the TOF distance sensors corresponds to a sensor cell.

The 3D sensor can also detect the distances of the individual sensor cells to a detected object based on a different measuring design. The 3D sensor can be part of a stereo camera or a triangulation system, for example.

The marking element can be of any design; it need only be clearly identifiable by the evaluation unit from the measurement data supplied by the 3D sensor. If the 3D sensor has TOF sensors, the marking element can for example be designed as a reflector for reflecting the electromagnetic radiation emitted by the transmitter in the direction of the 3D sensor. In this case, the evaluation unit can identify the marking element in the form of a reflector due to the fact that the reflector reflects much more electromagnetic radiation than its surroundings do. For example, the reflector has numerous small triple mirrors, and can be realized as a foil. Such reflectors are also used for example as so-called laser reflectors for reflecting laser beams.

The 3D Sensor has multiple sensor cells, in particular in the form of individual TOF sensors, arranged in particular in a matrix arrangement. A sensor cell can also be referred to as a pixel of the 3D sensor. The 3D sensor can have for example 160×60 or 320×240 sensor cells.

In an installation phase, the 3D sensor is arranged such that it detects the marking element and a region around the marking element as an object. Once this is accomplished, then the position of the elevator car in the elevator shaft can be determined and the system is in a normal mode. It is particularly important to ensure that the marking element is detected by the 3D sensor at every possible position of the elevator car, i.e., over the entire range of travel of the elevator car.

The evaluation unit is configured to determine the position of the elevator car in the elevator shaft based on distances of sensor cells from a part, detected by these sensor cells, of the object detected by the 3D sensor. It is also configured to continuously carry out a test of whether the 3D sensor detects the marking element. For this purpose, it can in particular determine sensor cells which detect the marking element. If it can determine one or more such sensor cells, then the 3D sensor detects the marking element and the test turns out positive. If it cannot determine such a sensor cell, the 3D sensor does not detect the marking element and the test is negative.

In this context, a continuous test means that the test is carried out repeatedly, in particular at a specified interval. The test can be carried out, for example, at a frequency of 1 to 100 Hz.

If the test fails, and the 3D sensor does not detect the marking element, then the evaluation unit brings the system for determining the position of the elevator car into an error mode. The evaluation unit then issues a corresponding signal or automatically brings the elevator installation into a safe state.

The determination of the sensor cells that detect the marking element can be carried out in a wide variety of ways. For example, the evaluation unit can recognize a characteristic distance pattern of the marking element. It is also possible for the marking element to actively emit electromagnetic radiation which can be detected by the sensor cells. By evaluating the intensity of the detected radiation, the evaluation unit can determine the sensor cells that detect the marking element.

To determine the position of the elevator car, the evaluation unit is configured for example to determine the position of the elevator car in the elevator shaft based on the determined distances to the detected object of these sensor cells and/or of sensor cells which are arranged in a region adjacent to these sensor cells. It is possible for only one sensor cell to detect the marking element. In this case, the evaluation unit can determine the position of the elevator car based on the determined distance of this sensor cell from the detected object, for example. It is also possible for the evaluation unit to evaluate the measurement data of one or more sensor cells adjacent to the mentioned sensor cell. For example, the position of the elevator car can be determined based on an average value of the determined distances of these sensor cells from the detected object. It is also possible for multiple sensor cells to detect the marking element. In this case, the evaluation unit can determine the position of the elevator car based for example on an average value of the determined distances of these sensor cells from the detected object. Sensor cells adjacent to the mentioned sensor cells can also be evaluated. For example, one or two rows of sensor cells which adjoin the sensor cells detecting the marking element can be evaluated in all directions. It is also possible that not the sensor cells detecting the marking element are evaluated, but sensor cells that have a small distance from the sensor cells detecting the marking element. These sensor cells are also arranged in a region adjacent to the sensor cells detecting the marking element. The mentioned region does not necessarily have to directly adjoin the sensor cells detecting the marking element.

In an embodiment of the invention, the evaluation unit is configured to carry out the test such that it turns out negative if the 3D sensor does not detect the marking element for an uninterrupted span of time having a specified duration. This has the advantage of preventing the system from being put into error mode unnecessarily. The mentioned time period can be for example 10-1000 ms.

In an embodiment of the invention, the marking element is arranged and has a spatial extension such that a characteristic distance pattern is produced in relation to the 3D sensor. The evaluation unit is then configured to determine the sensor cells that are detecting the marking element on the basis of the distance pattern of the marking element. The marking element can thus be designed in a particularly simple and cost-effective manner.

The marking element can for example be designed as a geometric body in the form of a cylinder with a known height, wherein the axis of rotation of the cylinder is oriented in particular in the direction of the 3D sensor. In this case, the characteristic distance pattern is designed such that a circular surface has a distance that is less than its immediate surroundings by the known height of the cylinder. Such a distance pattern can be easily recognized by the evaluation unit using known pattern recognition methods. In this case, all sensor cells lying within the mentioned circular surface would be those that detect the marking element.

In an embodiment of the invention, the marking element is designed such that it actively emits electromagnetic radiation. The sensor cells of the 3D sensor are then designed such that they can detect the electromagnetic radiation emitted by the marking element. In addition, the 3D sensor is designed such that it transmits, per sensor cell, an intensity characteristic variable characterizing the quantity of the mentioned electromagnetic radiation to the evaluation unit. The evaluation unit is here configured to determine the sensor cells detecting the marking element on the basis of the mentioned intensity characteristic variables. The sensor cells detecting the marking element can thus be determined particularly reliably.

In this case, the sensor cells are designed in particular as PMD sensors, which in addition to the distance of the detected object can calculate a so-called gray value from the intensity of the detected electromagnetic radiation. This gray value is then an intensity characteristic variable characterizing the quantity of the mentioned electromagnetic radiation, which variable is transmitted to the evaluation unit. Due to the emission of the mentioned electromagnetic radiation by the marking element, the sensor cells detecting the marking element determine a particularly high intensity of the detected electromagnetic radiation and can thus be determined particularly easily by the evaluation unit.

In this case, the electromagnetic radiation emitted by the marking element has in particular the same or at least a similar wavelength as the electromagnetic radiation emitted by the transmitter of the TOF camera comprising the sensor cells. In any case, the electromagnetic radiation emitted by the marking element is selected such that it can be detected by the 3D sensor.

In an embodiment of the invention, the marking element has an LED, in particular an infrared LED. The marking element can also have more than one LED. As LEDs are commercially available at very low cost, the marking element can be produced particularly cost-effectively. TOF camera transmitters in particular emit infrared light as electromagnetic radiation. For this reason, an infrared LED, i.e., an LED that emits infrared light, can be used particularly advantageously. However, LEDs can also be used which emit visible light.

In an embodiment of the invention, the evaluation unit is configured to determine those sensor cells which detect the marking element, and to determine the position of the elevator car in the elevator shaft on the basis of the determined distances from the detected object of these sensor cells and/or of sensor cells which are arranged in a region adjacent to the mentioned sensor cells. This ensures a particularly reliable determination of the position of the elevator car.

In particular, a reflector is arranged around the marking element or adjacent to the marking element for reflecting the electromagnetic radiation emitted by the transmitter in the direction of the 3D sensor. A particularly accurate and reliable determination of the position of an elevator car in an elevator shaft is thereby possible.

A reflector reflects a particularly large amount of the electromagnetic radiation emitted by the TOF camera transmitter. The distance between the sensor cells of the 3D sensor and the reflector can thus be determined very accurately and reliably. The reflector can have a square cross section, for example, and the marking element can be arranged at the center of the cross section. The reflector can also have a circular or rectangular cross section, for example, and the marking element can be arranged in the center of the cross section. It is also possible for the marking element to be adjacent to the reflector at a known side, and for the evaluation unit to be configured to determine the position of the elevator car based on the determined distances from the detected object of sensor cells that detect the reflector.

It must be noted that some of the possible features and advantages of the invention are described herein with reference to different embodiments of the system according to the invention and the method according to the invention. A person skilled in the art recognizes that the features may be combined, adapted, transferred or exchanged as appropriate in order to yield other embodiments of the invention.

Further advantages, features and details of the invention can be found in the following description of embodiments and with reference to the drawings, in which like or functionally like elements are provided with identical reference signs. The drawings are merely schematic and are not to scale.

### DESCRIPTION OF THE DRAWINGS

In the figures:

FIG. 1 shows a schematic representation of an elevator installation with a system for determining the position of an elevator car arranged movably in an elevator shaft,

FIG. 2 shows a schematic representation of a 3D sensor with 36 sensor cells, and

FIG. 3 shows a marking element according to an alternative embodiment.

### DETAILED DESCRIPTION

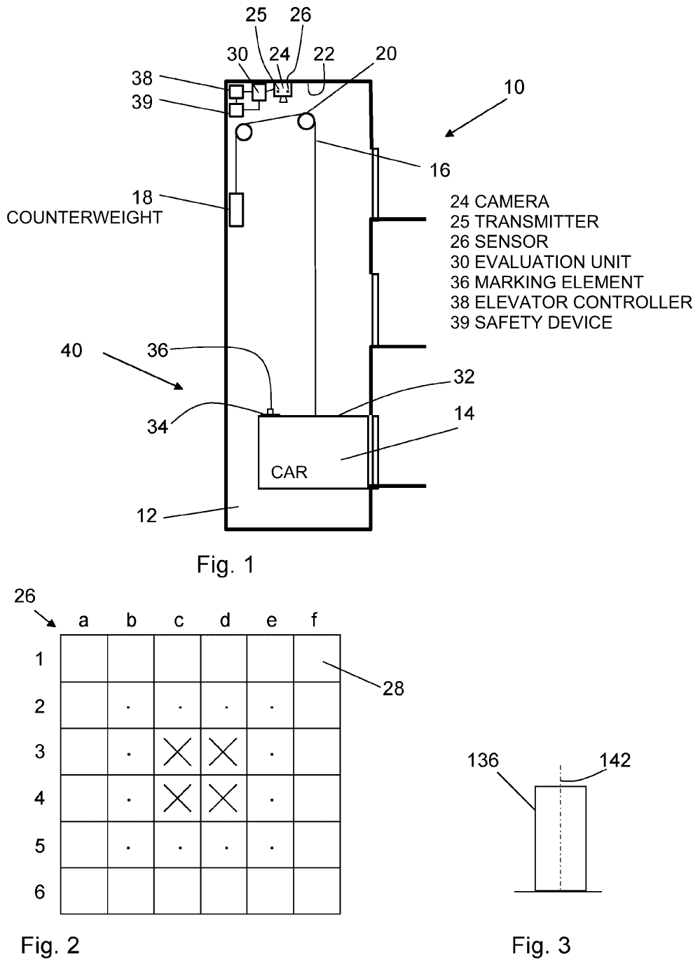

According to FIG. 1, an elevator installation 10 has an elevator shaft 12 extending in the vertical direction. An elevator car 14 is arranged within the elevator shaft 12, which car is connected to a counterweight 18 in a known manner via a support means 16 in the form of a flexible belt or a cable. Starting from the elevator car 14, the support means 16 runs over a drive pulley 20, which can be driven by a drive machine (not shown). The elevator car 14 can be moved up and down in the elevator shaft 12 by means of the drive machine and the support means 16.

A 3D camera in the form of a TOF camera 24 is immovably arranged on a shaft ceiling 22 of the elevator shaft 12. The TOF camera 24 has a transmitter 25 for emitting electromagnetic radiation, and a 3D sensor in the form of a PMD sensor 26. The PMD sensor 26 is shown very schematically in FIG. 2; it has a total of 36 sensor cells 28, which are arranged in 6 columns a-f and 6 rows 1-6. The PMD sensor 26 is configured to determine, for each sensor cell 28, a propagation time of the electromagnetic radiation emitted by the transmitter 25 and reflected by an object detected by the PMD sensor 26, and to transmit it to an evaluation unit 30 via a communication link. The evaluation unit 30 is configured to determine the distance of each sensor cell 28 from a part, detected by this sensor cell, of the object detected by the PMD sensor 26 on the basis of the mentioned propagation times.

It is also possible for the PMD sensor to transmit measurement data to the evaluation unit and for the evaluation unit to use this data to determine the named propagation times and thus the named distances. The evaluation unit can also be part of the TOF camera.

A reflector 34 having a square diameter is arranged on a car ceiling 32 of the elevator car 14. The reflector 34 is arranged such that it reflects electromagnetic radiation emitted by the transmitter 25 of the TOF camera 24 to the TOF camera 24 and thus to the PMD sensor 26. A marking element in the form of an infrared LED 36 is arranged centrally in the reflector 34. The infrared LED 36 actively emits electromagnetic radiation with a wavelength similar to that of the transmitter 25 of the TOF camera 24.

In an installation phase, the TOF camera 24 and thus also the PMD sensor 26 are arranged and aligned in such a way that the PMD sensor 26 detects the infrared LED 36 and at least one region around the infrared LED 36 as an object. Particular care is taken here to ensure that the infrared LED 36 is detected by the PMD sensor 26 at every possible position of the elevator car 14 in the elevator shaft 12, i.e., over the entire range of travel of the elevator car 14.

To determine the position of the elevator car 14 in the elevator shaft 12, i.e., to determine the height at which the elevator car 14 is located in the elevator shaft 12, the TOF camera 24 and thus the PMD sensor 26 detect as an object at least that part of the car roof 32 on which the reflector 34 and the infrared LED 36 are arranged. The evaluation unit 30 determines, for each sensor cell 28, the distance to the part, detected by this sensor cell 28, of the object detected by the PMD sensor 26, on the basis of the propagation time of the electromagnetic radiation emitted by the transmitter 25 and reflected by the detected object.

The sensor cells 28 of the PMD sensor 26 can also determine a so-called gray value from the intensity of the detected electromagnetic radiation. The mentioned intensity is particularly high in the sensor cells detecting the infrared LED 36 so that these sensor cells output a particularly high gray value. The gray value can thus be referred to as an intensity characteristic variable that characterizes the quantity of electromagnetic radiation detected by a sensor cell.

For each sensor cell 28, the PMD sensor 26 transmits the mentioned gray value and the determined distance to the detected object to the evaluation unit 30. The evaluation unit 30 is configured to, in a first step, determine the sensor cells 28 detecting the infrared LED 36. For this purpose, the evaluation unit 30 selects the sensor cells 28 with a particularly high gray value. In the example shown in FIG. 2, these are the sensor cells c3, c4, d3, and d4 marked with a cross (the letter indicates the column and the number indicates the row of the corresponding sensor cell in the matrix arrangement of the sensor cells 28). To determine the position of the elevator car 14 in the elevator shaft 12, the evaluation unit 30 determines the average value of the distances of the sensor cells b2, c2, d2, e2, b3, b4, b5, c5, d5, e5, e4, e3 that are marked with a dot and are adjacent to the sensor cells c3, c4, d3, and d4 that are detecting the infrared LED 36. The sensor cells b2, c2, d2, e2, b3, b4, b5, c5, d5, e5, e4, e3 used to determine the position of the elevator car 14 all detect the reflector 34 arranged around the infrared LED 36, which enables the position to be determined particularly accurately.

The position of the elevator car 14 is then determined from the aforementioned average value of the distances, the known position of the PMD sensor 26 in the elevator shaft 12, and the known position of the infrared LED 36 or of the reflector 34 on the elevator car 14. The evaluation unit 30 transmits the position of the elevator car 14 to an elevator controller 38, which uses it for example to control the drive machine.

A system 40 for determining the position of the elevator car 14, arranged movably in the elevator shaft 12, of the elevator installation 10 thus has a 3D sensor in the form of the PMD sensor 26, the evaluation unit 30 in communicative connection with the PMD sensor 26, and a marking element in the form of the infrared LED 36.

The evaluation unit can also determine the position of the elevator car in the elevator shaft on the basis of the sensor cells c3, c4, d3, and d4 that detect the infrared LED. It is also possible that between the sensor cells c3, c4, d3, d4 detecting the infrared LED and the sensor cells used to determine the position of the elevator car, a small distance of, for example, one sensor cell is left, and the evaluation unit thus uses the sensor cells a1-f1, f2-f5, a6-f6, and a2-a5 arranged at the very edge of the PMD sensor 26 to determine the position of the elevator car.

It is also possible for the reflector to act as the marking element. The evaluation unit can then also determine the sensor cells detecting the marking element using the gray value described above, because the reflector reflects a particularly large amount of the electromagnetic radiation emitted by the transmitter back to the PMD sensor.

As shown in FIG. 3, the marking element can also be designed as a cylinder 136 having a known height, wherein the axis of rotation 142 of the cylinder 136 is aligned in the direction of the PMD sensor (not shown in FIG. 3). The marking element in the form of the cylinder 136 does not emit any electromagnetic radiation. Due to the cylindrical design of the marking element, the detection by the PMD sensor results in a characteristic distance pattern for the marking element in the form of a circular surface which has a distance to the PMD sensor smaller by the known height of the cylinder 136 than to its immediate surroundings. Such a distance pattern can be easily recognized by the evaluation unit using known pattern recognition methods. In this case, all sensor cells lying within the mentioned circular surface would be those that detect the marking element.

It is also possible for the TOF camera to be arranged on a shaft floor and for the marking element to be arranged on a car floor of the elevator car. It is also possible for the TOF camera to be arranged on the elevator car and for the marking element to be arranged immovably in the elevator shaft.

In addition to the described determination of the position of the elevator car in the elevator shaft, the evaluation unit 30 performs a test, at a definable frequency of, for example, 20 Hz, to determine whether the 3D sensor 26 is detecting the marking element 36. In accordance with the procedure described above, it tests whether at least one sensor cell 28 detects the marking element 36. The test returns a positive result when at least one sensor cell 28 detects the marking element 36. The test is negative if none of the sensor cells 28 has detected the marking element 36 for an uninterrupted time period of, for example, 150 ms.

If the test is positive, the system 40 is in normal mode and the evaluation unit 30 transmits the determined position of the elevator car 14 and information about its normal mode to the elevator controller 38 and to a safety device 39 of the elevator installation 10. In this case, the safety device 39 allows the elevator system 10 to be operated and the elevator car 14 can be moved in the elevator shaft as determined by the elevator controller 38.

If the test is negative, the evaluation unit 30 immediately brings the system 40 into an error mode. The evaluation unit 30 then transmits an item of information about its error mode to the elevator control unit 38 and to the safety device 39 of the elevator system 10. As a result, the safety device 39 immediately interrupts the operation of the elevator installation 10 and the elevator car 14 can no longer be moved in the elevator shaft.

Finally, it should be noted that terms such as “having,” “comprising,” etc. do not preclude other elements or steps, and terms such as “a” or “an” do not preclude a plurality. Furthermore, it should be noted that features or steps which have been described with reference to one of the above embodiments may also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-11. (canceled)

12. A system for determining a position of an elevator car movable in an elevator shaft of an elevator system, the system comprising:
a 3D sensor;
an evaluation unit in communication with the 3D sensor;
a marking element, wherein one of the 3D sensor and the marking element is arranged immovably in the elevator shaft and another of the 3D sensor and the marking element is arranged on the elevator car;
wherein the 3D sensor has a plurality of sensor cells that generate measurement data when an object is detected and the evaluation unit is adapted to determine a distance of each of the sensor cells from a part of the object detected by the sensor cell;
wherein the 3D sensor, in a normal mode of the system, detects the marking element as the object and the evaluation unit determines a position of the elevator car in the elevator shaft based on ones of the sensor cells that detect the marking element; and
wherein the evaluation unit continuously tests whether the 3D sensor detects the marking element and brings the system into an error mode when the test is negative for detection of the marking element.

13. The system according to claim 12 wherein the evaluation unit determines that the test is negative when the 3D sensor does not detect the marking element for an uninterrupted span of time having a specified duration.

14. The system according to claim 12 including a transmitter emitting electromagnetic radiation, wherein the 3D sensor determines for each of the sensor cells a propagation time of the electromagnetic radiation emitted by the transmitter and reflected from the detected object, and wherein the evaluation unit determines the distance of each of the sensor cells from the detected part of the object based on the propagation times.

15. The system according to claim 12 wherein the marking element is arranged and has a spatial extent such that a characteristic distance pattern is produced relative to the 3D sensor, and the evaluation unit determines the ones of the sensor cells that are detecting the marking element based on the characteristic distance pattern of the marking element.

16. The system according to claim 12 wherein the marking element actively emits electromagnetic radiation, the sensor cells are adapted to detect the electromagnetic radiation emitted by the marking element, the 3D sensor transmits to the evaluation unit an intensity characteristic variable characterizing a quantity of the electromagnetic radiation detected by each of the sensor cells, and the evaluation unit determines the ones of the sensor cells detecting the marking element based on the intensity characteristic variables.

17. The system according to claim 16 wherein the marking element includes an LED.

18. The system according to claim 17 wherein the LED is an infrared LED.

19. The system according to claim 12 wherein the evaluation unit determines the ones of the sensor cells that detect the marking element, and the evaluation unit determines the position of the elevator car in the elevator shaft based on the determined distances to the detected object of the sensor cells that detect the marking element and/or ones of the sensor cells arranged in a region adjacent to the sensor cells that detect the marking element.

20. The system according to claim 19 including a reflector arranged around the marking element or adjacent to the marking element, the reflector reflecting the electromagnetic radiation emitted by a transmitter in a direction of the 3D sensor.

21. An elevator installation comprising:
the system according to claim 12;
an elevator shaft;
an elevator car movable in the elevator shaft; and
wherein the system is arranged in the elevator shaft and on the elevator car.

22. A method for determining a position of an elevator car movably arranged in an elevator shaft of an elevator installation, the method comprising the steps of:
providing the system according to claim 12;
operating the evaluation unit to determine the position of the elevator car in the elevator shaft based on distances of each of the sensor cells from a part of the detected object;
wherein the evaluation unit continuously carries out a test of whether the 3D sensor detects the marking element; and
wherein the evaluation unit brings the system into an error mode when the test is negative for detection of the marking element.
